(19) United States
(12) Patent Application Publication
(10) Pub. No.: US 2020/0188236 A1
(43) Pub. Date: Jun. 18, 2020

(54) A DISCRETE AND PORTABLE EMESIS BAG AND TOWELETTE

(71) Applicants: Robin Rae Wright, Simi Valley, CA (US); Melanie Rae Elaine Wright, Reseda, CA (US)

(72) Inventors: Robin Rae Wright, Simi Valley, CA (US); Melanie Rae Elaine Wright, Reseda, CA (US)

(21) Appl. No.: 16/508,723

(22) Filed: Jul. 11, 2019

Related U.S. Application Data
(60) Provisional application No. 62/778,735, filed on Dec. 12, 2018.

(51) Int. Cl. A61J 19/00; B65D 75/30; B65D 75/58

(52) U.S. Cl. CPC A61J 19/00; B65D 75/5805; B65D 75/30

(57) ABSTRACT

A package comprising: an envelope; an emesis bag; and a moist towelette. The device serves as a convenient, portable, all-in-one emesis collection and cleanup kit. The envelope is configured to fit within a pocket of a user without folding and is further configured to contain the moist towelette and the emesis bag.

### CROSS REFERENCE PARAGRAPH

This application claims the benefit of and priority to U.S. Provisional Patent Application No. 62/778,735 filed on Dec. 12, 2018, the contents of which are incorporated herein by reference in its entirety.

### FIELD OF USE

The present disclosure relates generally to emesis bags, wipes, and sanitary packaging for the same. More specifically, the present disclosure relates to an individually wrapped, package which may be easily and portably stored and carried for later use.

### BACKGROUND

Emesis bags (otherwise known as sickness bags, motion sickness bags, or vomit bags) are small bags that are used to collect and contain an individual's vomit, usually in an urgent situation. Emesis bags are most frequently used in situations in which vomiting occurs suddenly and without warning, such as on airplanes or boats, in which passengers may vomit due to unexpected motion sickness. They are also commonly used in hospitals and other settings in which sick patients receive care. Used properly, an emesis bag may significantly help with cleanup and containment after such incidents.

Currently, emesis bags are not packaged as a single or individual item. Rather, emesis bags are provided in boxes or packaging which may contain several plastic bags per box (approximately 10-20). Further, current emesis bags are big and bulky and frequently have solid plastic rings attached that are not conducive to discretely carrying individual emesis bags in a purse or pocket. Due to the lack of individually packaged emesis bags, users of emesis bags are therefore forced to make do with emesis bags which are not conducive to being discretely and easily carried.

Thus, what is needed is a convenient, discrete, and portable emesis bag that is discrete and includes clean-up products.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a package. In some embodiments, the emesis bag and moist towelette are packaged within an envelope. The envelope is preferably small enough to be easily and discretely carried by a user, such as by fitting within a user's pocket, purse, or backpack.

In one embodiment, the moist towelette may be individually packaged, having its own moist towelette packaging which is itself packaged within the larger envelope of the package.

In another embodiment, the emesis bag may be individually packaged, having its own emesis bag packaging in addition to the envelope.

In other embodiments, the moist towelette and emesis bag may both be individually packaged within the envelope; or the moist towelette and emesis bag may both lack additional individual packaging within the envelope; or one or the other of the moist towelette and emesis bag may have additional packaging within the envelope, or any combination thereof.

In some embodiments, the envelope may have a perforated or notched portion to allow for users to easily tear the envelope and access the emesis bag and moist towelette contained therein.

Still other advantages, embodiments, and features of the subject disclosure will become readily apparent to those of ordinary skill in the art from the following description wherein there is shown and described a preferred embodiment of the present disclosure, simply by way of illustration of one of the best modes suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a package, in which the pre-packaged emesis bag and moist towelette are contained within the pictured envelope.

FIG. 2 is a partially exploded view of one embodiment of a package, showing an opened envelope, and the emesis bag and moist towelette contained therein.

FIG. 3 is partially exploded view of another embodiment of a package, showing an opened envelope, an emesis bag, and a pre-packaged moist towelette contained therein.

FIG. 4 is an illustration of one embodiment of a package, showing an unfolded emesis bag and a packaged moist towelette after removal from the envelope.

FIG. 5 is an illustration of another embodiment of a package, showing an unfolded emesis bag, an unfolded moist towelette, an opened moist towelette packaging, and an opened envelope.

FIG. 6 is an illustration of one embodiment of a package, demonstrating the portability of the package as it fits into the pocket of a user.

FIG. 7 is an illustration of another embodiment of a pre-packaged emesis bag being removed from a small bag carried by a user, such as a purse or backpack.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signified both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

As used herein, the term “envelope” refers to the outermost packaging of the package of the present disclosure. The envelope may be made from a variety of materials, appropriate for conveniently and sanitarily storing an emesis bag and moist towelette. The emesis bag and/or the moist towelette may themselves be further individually packaged or wrapped, so long as the emesis bag and moist towelette are still packaged in such dimensions as to allow them to fit within the envelope.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

In accordance with the embodiments disclosed herein, the present disclosure is directed to a package. In some embodiments, the emesis bag and moist towelette may be packaged within an envelope. The envelope may preferably be small enough to be easily and discretely carried by a user, such as by fitting within a user's pocket, purse, or backpack.

In one embodiment, the package of the present disclosure may comprise an emesis bag and a moist towelette that are folded and contained/packaged within an envelope. The envelope is preferably configured to fit easily in a pocket or purse.

The package of the present disclosure serves as a convenient, portable, all-in-one emesis collection and cleanup kit. The bag and towelette may be contained in a heat-sealed bag made from Biaxially-oriented polyethylene terephthalate (BoPET) commonly referred to as Mylar®.

It is to be understood that the size dimensions of the envelope, emesis bag, and moist towelette may cover a variety of sizes while still being within the scope of the present disclosure, and that any specific sizes or size ranges are not intended to be limiting but are provided as examples only.

In one embodiment, the package may be one (1) 3¾×2¾ inches by ⅜ inches thick heat-sealed BoPET envelope that contains one plastic emesis bag and one individually wrapped moist towelette. The emesis bag and moist towelette may be folded to allow them to fit inside the envelope. When unfolded, the emesis bag and moist towelette may have dimensions of 9½″×9½″ and 8½″×5″, respectively.

In other embodiments, the package may be one (1) heat-sealed BoPET envelope, with a size ranging from 2½×2½ inches to 4×4 inches. In some embodiments, the emesis bag may have dimensions ranging from 8×8 inches to 12×12 inches, while still being foldable to a small enough size to fit within the envelope. In other embodiments, the moist towelette may have dimensions ranging from 7×4 inches to 9×6 inches, while still being foldable to a small enough size to fit within the envelope.

The moist towelette may be individually wrapped within its own moist towelette packaging. This moist towelette packaging, containing the moist towelette, may be present inside the envelope, along with the emesis bag. In some embodiments, the moist towelette packaging may have dimensions ranging from 2×2 inches to 3¾×3¾ inches.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

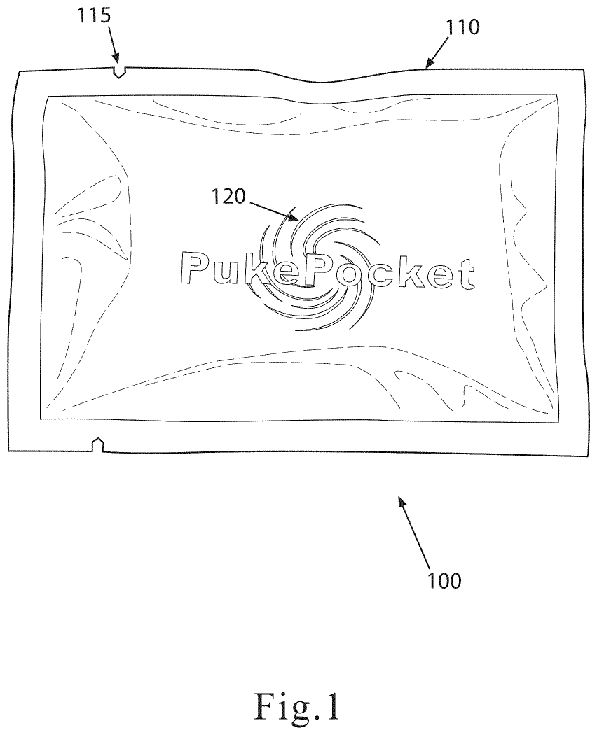

FIG. 1 is an illustration of one embodiment of a package. The package 100 may comprise an envelope 110 containing an emesis bag and moist towelette. The envelope 110 may include one or more notches 115 to allow for easy opening of the envelope 110 by tearing. The sealed envelope 110 serves to keep the contained emesis bag and moist towelette sanitary. The envelope 110 may be stamped with a logo 120 for branding purposes.

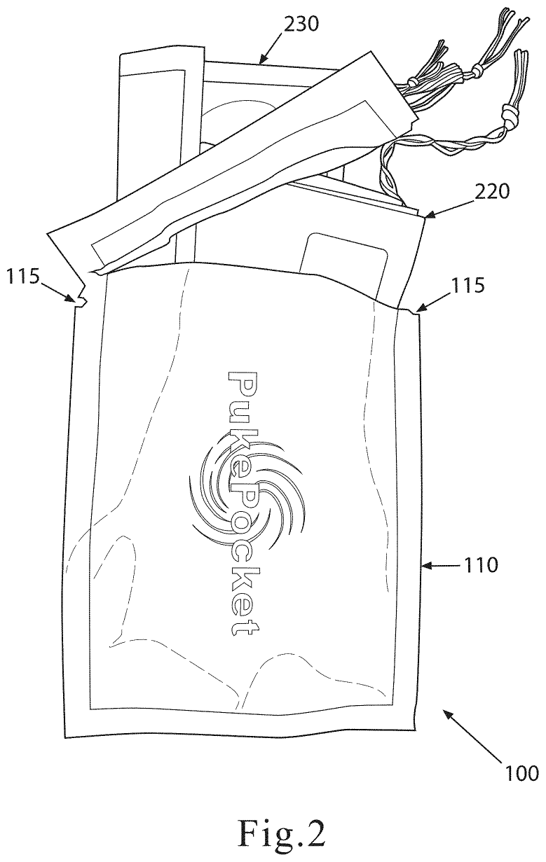

FIG. 2 is an illustration of one embodiment of a package. The package 100 may comprise an envelope 110 in a partially opened configuration. When the envelope 110 is opened from one of the notches 115, the emesis bag 220 and moist towelette pouch 230 contained therein may be accessed and removed by a user. The moist towelette pouch 230 may contain a moist towelette. The emesis bag 220 may be plastic, or other suitable material such that material, especially liquid material, placed inside the emesis bag 220 becomes trapped within the emesis bag, such that the emesis bag is leak proof or resistant to leaking.

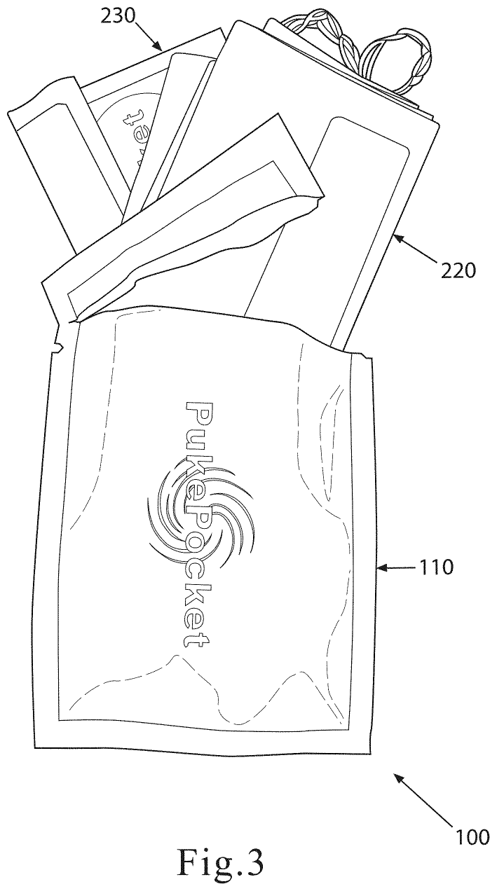

FIG. 3 is an illustration of an embodiment of a package. The package 100 may comprise an envelope 110 in a partially opened configuration, showing the emesis bag 220 and moist towelette pouch 230 contained therein. To ensure that the moist towelette remains sanitary and fit for cleanup after using the emesis bag 220, the moist towelette may be separately and individually packaged from the emesis bag 220, within the moist towelette pouch 230. Much as in FIG. 2, the emesis bag 220 and the moist towelette pouch 230 may be accessible after tearing open the envelope 110, preferably by tearing at one of the notches 115 that may be present on the envelope 110.

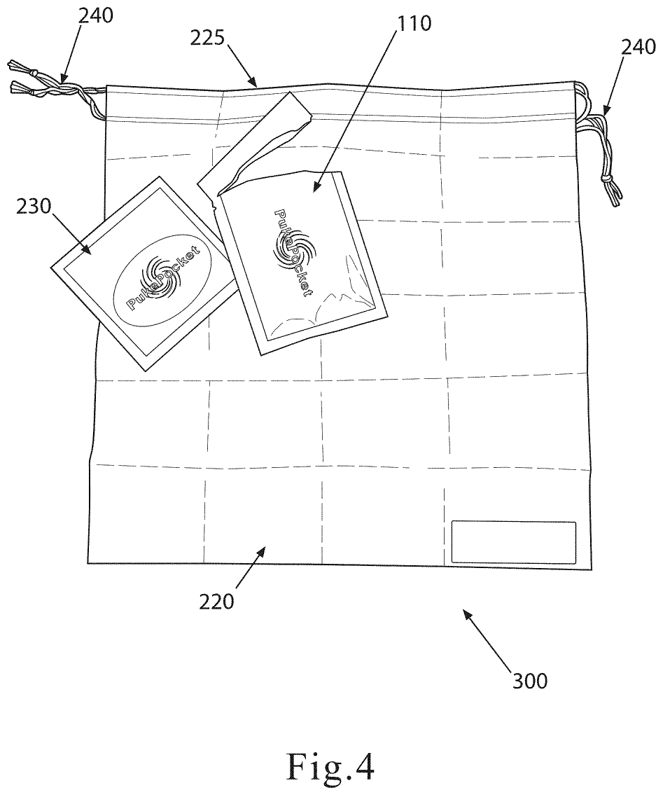

FIG. 4 is an illustration of an embodiment of a package, which separately shows an envelope 110 in an opened configuration, an emesis bag 220, and a moist towelette pouch 230. The emesis bag 220 may fit inside the envelope 110 by being folded repeatedly. After removal from the envelope 110, the emesis bag 220 may be unfolded before use. The emesis bag 220 may contain an opening 225, which may allow the emesis bag 220 to be opened to receive a person's emetic discharge, or vomit. The moist towelette pouch 230 may contain a moist towelette. The moist towelette may then be used as the user sees appropriate, such as for cleaning up any emesis that did not make it into the bag 220.

In preferred embodiments, the emesis bag opening 225 may be equipped with a closure mechanism 240 so that the emesis bag 220 may be sealed to contain the emetic discharge and associated unpleasant smells. The closure mechanism 240 may be a zip closure, an adhesive closure, tie handles, twist ties, a drawstring closure, or any other way of sealing the emesis bag 220.

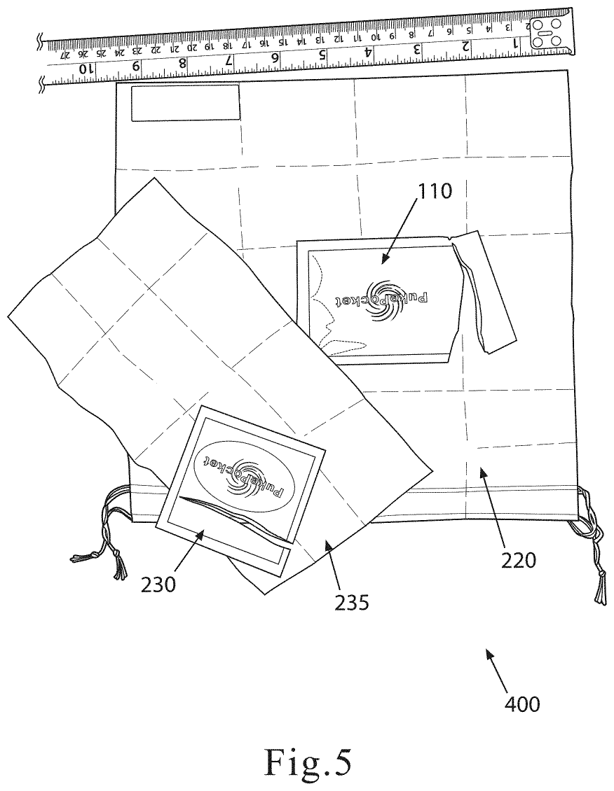

FIG. 5 is an illustration of another embodiment of the package of the present disclosure, showing potential relative sizes of the envelope 110 in an opened configuration, the emesis bag 220, the moist towelette pouch 230, and the moist towelette 235. In preferred embodiments, the emesis bag 220 may be about 3″ by 2″ while folded inside the envelope 110, and may be unfolded to be approximately 9.5″ by 9.5″ in size. FIG. 5 also shows the moist towelette 235 removed from its individually wrapped moist towelette pouch 230. The envelope 110 is included to show the size ratios of the constituent parts of the present disclosure.

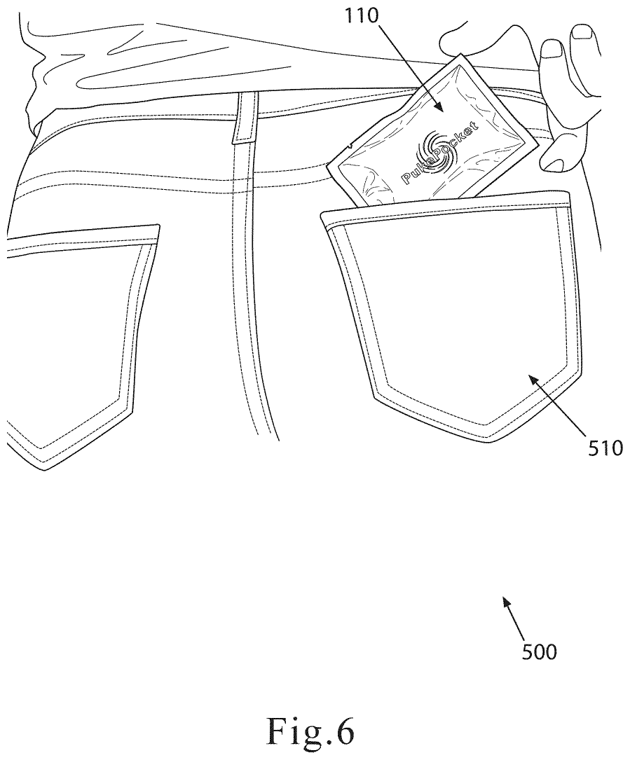

FIG. 6 is an illustration of one embodiment of the package of the present disclosure, showing that the envelope 110 is portable, discrete, and may fit inside a pocket 510 of a user.

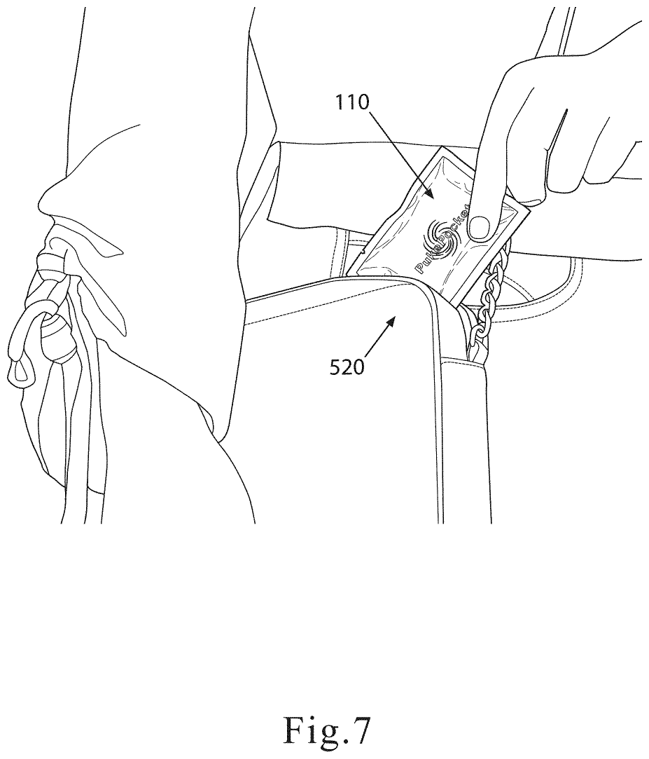

FIG. 7 is an illustration of another embodiment of the package of the present disclosure, showing that the package 100 is portable, discrete, and may fit inside a purse 520 of a user. The purse 520 need not specifically be a purse, but may be any portable bag easily carried by a user, such as a backpack, fanny pack, messenger bag, etc. The package 100 may be stored in any other desirable and convenient location, such as vehicle gloveboxes and storage closets/cabinets.

In sum, the package 100 of the present disclosure may be stored in any location that would provide a sick individual, or the caretaker of a sick individual, with easy and rapid access to an emesis bag and moist towelette in the event of an emetic episode, whether expected or unexpected.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; or the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A package comprising:
an envelope;
an emesis bag; and
a moist towelette;
wherein said envelope contains said emesis bag and said moist towelette.

2. The package of claim 1, wherein said emesis bag is leak resistant.

3. The package of claim 1, wherein said emesis bag is plastic.

4. The package of claim 1, wherein said emesis bag is odor trapping, such that said emesis bag prevents odors from emanating from the contents of said emesis bag.

5. The package of claim 4, wherein said emesis bag is scented.

6. The package of claim 1, wherein said envelope is made from biaxially-oriented polyethylene terephthalate (BoPET) and is heat-sealed to secure said emesis bag and said moist towelette.

7. The package of claim 1, wherein said emesis bag comprises a closure means.

8. The package of claim 1, further comprising a moist towelette pouch;
wherein said moist towelette is configured to fit within said moist towelette pouch.

9. The package of claim 1, wherein said envelope comprises one or more notches;
wherein said one or more notches comprise a small indentation along an edge of said envelope, such that a user may open said envelope by ripping said envelope at the location of said one or more notches.

10. A package comprising:
an envelope; and
an emesis bag;
wherein said envelope contains said emesis bag.

11. The package of claim 10, further comprising a moist towelette.

12. The package of claim 11, further comprising a moist towelette pouch, wherein said moist towelette is configured to fit within said moist towelette pouch.

13. The package of claim 12, wherein said emesis bag is leak resistant.

14. The package of claim 13, wherein said emesis bag is plastic.

15. The package of claim 14, wherein said emesis bag is odor trapping, such that said emesis bag prevents odors from emanating from the contents of said emesis bag.

16. The package of claim 15, wherein said emesis bag is scented.

17. The package of claim 16, wherein said envelop is made from biaxially-oriented polyethylene terephthalate (BoPET) and is heat-sealed to secure said emesis bag and said moist towelette.

18. The package of claim 17, wherein said emesis bag comprises a closure means.

19. The package of claim 17, wherein said envelope comprises one or more notches;
wherein said one or more notches comprise a small indentation along an edge of said envelope, such that a user may open said envelope by ripping said envelope at the location of said one or more notches.

20. A package comprising:
an envelope;
an emesis bag;
a moist towelette; and
a moist towelette pouch;
wherein said emesis bag is leak resistant;
wherein said envelope is made from BoPET and is heat-sealed;
wherein said emesis bag is scented and odor trapping, such that said emesis bag prevents odors from emanating from the contents of said emesis bag;
wherein said moist towelette is configured to fit within said moist towelette pouch;
wherein said package is configured to fit within a pocket of a user without folding;
wherein said envelope is configured to contain said emesis bag and said moist towelette;
wherein said envelope comprises one or more notches;
wherein said one or more notches comprise a small indentation along an edge of said envelope, such that a user may open said envelope by ripping said envelope at the location of said one or more notches.
